(19) United States
(12) Patent Application Publication
(10) Pub. No.: US 2010/0229418 A1
(43) Pub. Date: Sep. 16, 2010

(54) Control Method of Dryer

(76) Inventor: Jun Seok Lee, Daegu (KR)

Correspondence Address: MCKENNA LONG & ALDRIDGE LLP, 1900 K STREET, NW, WASHINGTON, DC, 20006, US

(21) Appl. No.: 12/224,552

(22) PCT Filed: Mar. 9, 2007
(86) PCT No.: PCT/KR2007/001183

§ 371 Date: Aug. 29, 2008

(30) Foreign Application Priority Data
Mar. 9, 2006 (KR) 10-2006-0022300

(51) Int. Cl. F26B 7/00

(52) U.S. Cl. 34/427

(57) ABSTRACT

The present invention relates to a controlling method of a dryer for preventing spontaneous combustion, which can substantially enhance user's safety. The controlling method of a dryer includes: loading laundry in the dryer; locking a door of the dryer; performing drying for the laundry; and determining whether there is malfunction in the dryer.

### TECHNICAL FIELD

The present invention relates to a dryer. More specifically, the present invention relates to a controlling method of a dryer for preventing spontaneous combustion, which can substantially enhance user's safety.

### BACKGROUND ART

Generally, dryers are home appliances that are used to dry laundry by hot air supplied to a laundry holding space. There are dryers having only a drying function and laundry machines having a drying and washing function.

The dryers are typically categorized into an air exhaustion-type dryer and an air condensation-type dryer based on a drying method.

In the exhaustion-type dryer, damp air produced after drying laundry is exhausted outside. In the air condensation-type dryer, damp air produced after drying laundry is heat-exchanged with external air and the damp air is condensed to be changed into dry air. Then, the dry air is heated to be re-supplied to the laundry.

A method for controlling a conventional air condensation-type dryer will be now described in detail, referring to the drawings.

FIG. 1 is a longitudinal sectional view schematically illustrating a conventional air condensation-type dryer and FIG. 2 is a cross sectional view schematically illustrating the conventional air condensation-type dryer.

As shown in FIGS. 1 and 2, the air condensation-type dryer includes a body 10, a drum 11, a motor and a belt 19. The body 10 defines an exterior of the dryer and a door 12 is coupled to a front surface of the body 10. The drum 11 is rotatable within the body 10 and holds laundry therein. The motor 17 and the belt 19 are mounted in a lower portion of the body 10 to rotate the drum 11, communicating with each other.

The air condensation-type dryer further includes a condenser 13 and an air circulation duct 14. The condenser 13 is installed in the lower portion of the body 10. The condenser 13 condenses damp air passing the drum 11 and removes moisture from the damp air to change the damp air into dry air. Air is circulated through the circulation duct 14.

There are provided in the circulation duct 14 a heater 15 for heating the air passing through the condenser 13 and a circulation fan 16 for forcibly circulating the air.

Also, an external air supply duct 18, a cooling fan 20 and a cooling fan operation motor 21 are provided to condense the air after heat-exchanging the damp air passing the condenser 13 with external air. A water reservoir (not shown) is also provided under the condenser 13 to receive the water generated during the heat exchanging between the damp air and external air.

A method for controlling the conventional air condensation-type dryer will be now described.

Once a user introduces laundry such as clothes, cloth items and beddings into the drum 11 and operates the dryer, the motor 17 is operated to rotate the drum 11. Together with that, the heater 15 and the circulation fan 16 are operated to supply hot air to the drum 11. Thus, a drying cycle is performed.

Air is getting damp during the drying cycle. The damp air passes the condenser 13 through the circulation duct 14 to be condensed, and it is changed into dry air. At this time, the damp air passing the condenser 13 is heat-exchanged with external air that is forcibly ventilated to the condenser 13 by the cooling fan 20 and it is condensed to be dry air. The dry air is heated by the heater 15 and it is drawn into the drum 11 to dry the laundry.

This air circulation is repeatedly performed and the laundry inside the drum 11 is dried.

### DISCLOSURE OF INVENTION

### Technical Problem

However, the above conventional air condensation-type dryer has following disadvantages as follows.

First, if he/she opens the door during the drying, a user might get burned by hot air that is diffused suddenly from the dryer.

Furthermore, air condensation-type dryer has a closed structure that air is circulated without any connection with an outside. As a result, there might be an accident caused by spontaneous combustion during the drying for the laundry of which a piece has the inflammables, if a user opens the door.

That is, the hot piece of laundry having the inflammables is exposed to external air and spontaneous combustion might occur by chemical action with oxygen contained in the external air, which results in an accident such as a fire.

### Technical Solution

To solve the problems, an object of the present invention is to provide a controlling method of a dryer for preventing spontaneous combustion, which can substantially enhance user's safety.

To achieve these objects and other advantages and in accordance with the purpose of the invention, as embodied and broadly described herein, a controlling method of a dryer includes: loading laundry in the dryer; locking a door of the dryer; performing drying for the laundry; and determining whether there is malfunction in the dryer.

The controlling method of a dryer may further include: sensing the temperature inside a drum if there is malfunction and determining based on the sensed temperature whether the locking of the door is released.

The locking of the door is released if the sensed temperature inside the drum is below a predetermined first door-lock-release temperature.

It is preferred that the drying is stopped if the locking of the door is released and the door is opened. The controlling method of a dryer according to the present invention may further include re-locking the door and re-starting the drying, if a command for re-starting the drying is inputted.

The controlling method of a dryer according to the present invention may further include: re-locking the door and re-starting the drying, if the locking of the door is released and the door is not opened for a predetermined time period.

The drying is performed for a predetermined time period, if the drying re-starts.

The drying is performed for a predetermined time period if there is no malfunction in the dryer.

After performing the drying, the controlling method of a dryer may further includes: cooling the dried laundry; and sensing the temperature inside a drum of the dryer and determining based on the sensed temperature whether the locking of the door is released.

Here, the locking of the door is released if the sensed temperature inside the drum is below a predetermined second door-Jock-release temperature.

### ADVANTAGEOUS EFFECTS

The present invention has following advantageous effects.

First, according to the present invention, the door is opened only if the temperature inside the drum is below the predetermined temperature. As a result, user safety can be enhanced.

Furthermore, as mentioned above, the dried hot laundry is prevented from being exposed to external air suddenly. As a result, spontaneous combustion of the laundry and thus fires may be prevented in advance.

### BRIEF DESCRIPTION OF THE DRAWINGS

The accompanying drawings, which are included to provide further understanding of the disclosure and are incorporated in and constitute a part of this application, illustrate embodiments of the disclosure and together with the description serve to explain the principle of the disclosure.

In the drawings:

FIG. 1 is a longitudinal sectional view schematically illustrating a conventional air condensation-type dryer;

FIG. 2 is a cross sectional view schematically illustrating the conventional air con-condensation-type dryer; and

FIG. 3 is a flow chart illustrating a controlling method of a dryer according to an embodiment.

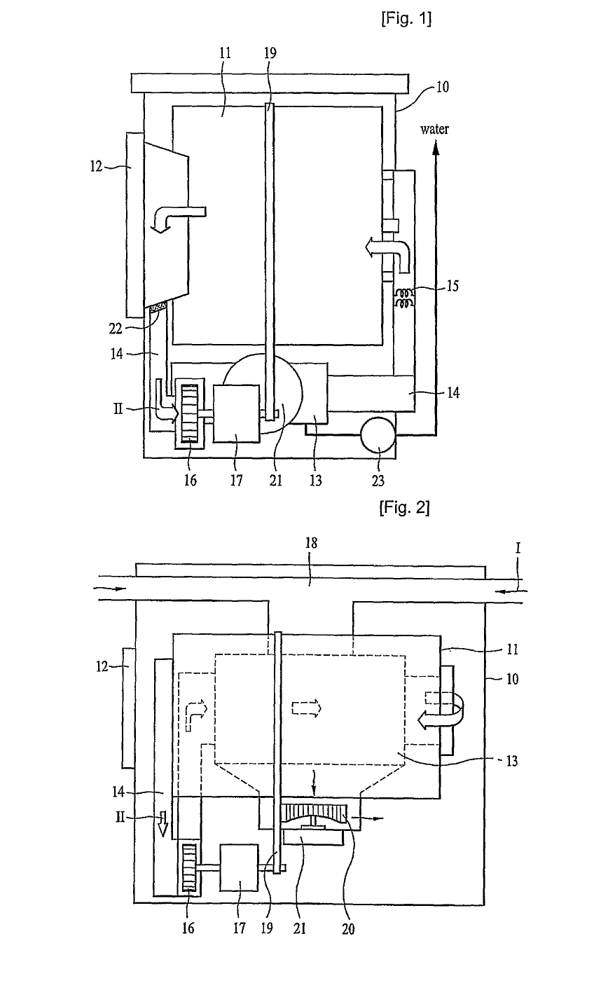

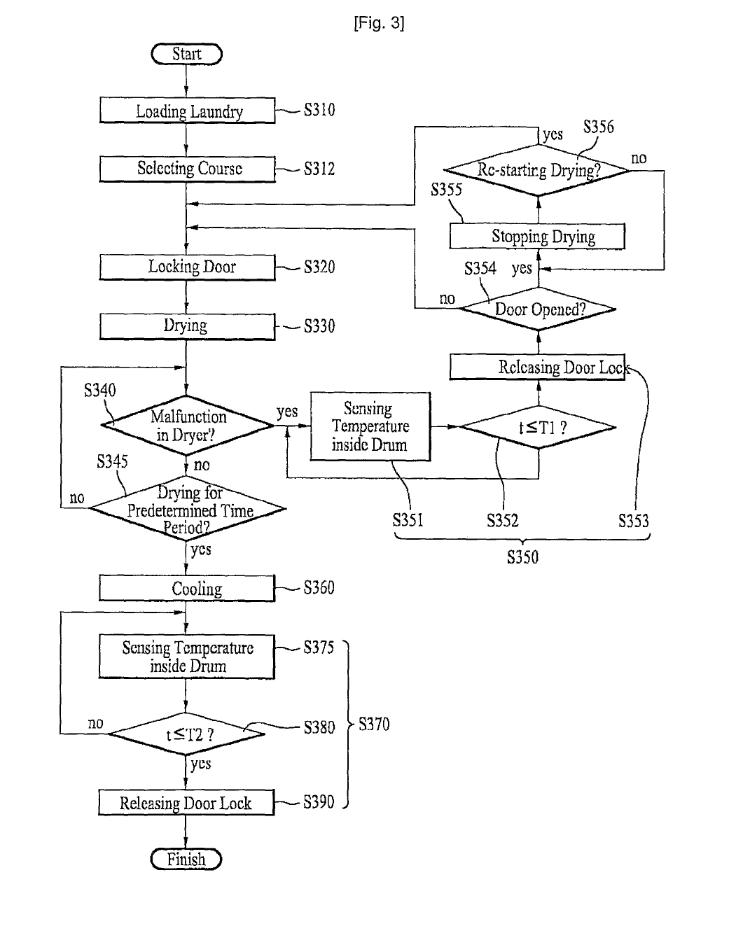

### BEST MODE FOR CARRYING OUT THE INVENTION

Reference will now be made in detail to the specific embodiments of the present invention, examples of which are illustrated in the accompanying drawings. Wherever possible, the same reference numbers will be used throughout the drawings to refer to the same or like parts.

In reference to FIG. 3, the preferred embodiment will be explained.

As shown in FIG. 3, a controlling method of a dryer according to a preferred embodiment includes steps of loafing laundry into a dryer (S310), locking a door of the dryer (S320), performing drying for the laundry (S330) and determining whether there is malfunction in the dryer (S340).

The controlling method of a dryer may further include a step of sensing the temperature inside the drum if there is malfunction and determining whether the locking of the door is released based on the sensed temperature (S350).

More specifically, in the step S350, the temperature inside the drum is sensed (S351) and the sensed temperature is compared with a predetermined first door-lock-release temperature (S352). Only if the sensed temperature is below the pre-determined first door-lock-release temperature, the locking of the door is released (S353).

Also, when the locking of the door is released and the door is opened (S354), it is preferred that the drying is stopped (S355). If a command for re-starting the drying is inputted (S356), a step may be further included that the door is re-locked (S320) and the drying re-starts (S330).

If the locking of the door is released and the door is not opened for a predetermined time period, the door is re-locked (S320) and the drying for the laundry may re-start (S330).

If the locking of the door is released and the door is not opened for a predetermined time period (S354), the door is re-locked (S320) and the drying re-start (S330).

When the drying is re-performed the drying is performed for a predetermined time period (S345).

In the step of determining whether there is malfunction in the dryer (S340), the drying is performed for a predetermined time period if no malfunction is detected in the dryer.

If the drying is completed there may be further included a step of cooling the dried laundry (S360) and a step of sensing the temperature inside the drum and determining whether the locking of the door is released (S370).

In the step of S370, the temperature inside the drum is sensed (S375) and the sensed temperature is compared with a predetermined second door-lock-release temperature (S380). Only when the sensed temperature is below the predetermined second door-lock-release temperature, the locking of the door may be released (S390).

The control method of a dryer having above configurations will be now described in detail.

First, a user loads laundry in the drum 11 and he/she selects appropriate courses corresponding to the kinds of the laundry (S312).

Once the user selects a drying course, the dryer locks the door automatically or based on a start command inputted by the user (S320), and the drying is performed (S330).

More specifically, hot air is supplied to the drum 11 by the heater 15 (see FIG. 1) and the circulation fan 16 (see FIG. 1). The hot air is heat-exchanged with the laundry inside the drum 11 and it sucks the moisture contained in the laundry to dry the laundry. The damp air passes the condenser 13 (see FIG. 1) through the circulation duct 14 (see FIG. 1), such that it is condensed and changed into dry air. At this time, the damp air that passes the condenser 13 is heat-exchanged with external air that is forcibly ventilated into the condenser 13 by the cooling fan 20 (see FIG. 1), to be condensed. The dry air is heated by the heater 15 and supplied to the drum 11. This air circulation process is repeated to dry the laundry.

During above drying, a controller (not shown) keeps detecting whether there is malfunction in the dryer such as malfunctions of various parts or operational errors (S340).

If it is determined that there is malfunction in the dryer based on the result of the detection, it is also determined based on the temperature inside the drum of the dryer whether the locking of the door is released (S350).

More specifically, if there is malfunction, a user recognizes the malfunction and opens the door of the dryer, which might results in user's burn. Thus, according to the present invention, if the user recognizes the malfunction, the locking of the door is not released immediately. The temperature inside the drum is sensed and only if the sensed temperature is below the predetermined temperature, the locking of the door is released to allow the user to open the door. As a result, user's burn which might be caused by the high temperature inside the drum can be prevented.

The step of determining whether the locking of the door is released (S350) includes a step of sensing the temperature inside the drum (S351), a step of comparing the sensed temperature with a predetermined first door-lock-release temperature T1 (S352), and a step of releasing the locking of the door if the sensed temperature is below the predetermined first door-lock-release temperature T1 (S353).

Specifically, the temperature inside the drum 11 is sensed by a temperature sensor (now shown) (S351). If the sensed temperature t is below the predetermined first door-lock-release temperature T1, the locking of the door is released (S353). If the sensed temperature t is higher than the first door-lock-release temperature T1, the locking of the door is maintained.

Hence, when the sensed temperature t is below the first door-lock-release temperature and the locking of the door is released the user opens the door 12 (S354) to check the dryer, for example, take a look at the laundry or unload the laundry. When the user opens the door 12, it is preferred that drying for the laundry is stopped (S355). If there is malfunction in the dryer, the user can call for service or fix it for him/her.

If no malfunction is found or the malfunction is proved as simple operational malfunction, the user re-starts the drying (S356). When the controller (not shown) recognizes the re-starting of the drying, the door 12 is re-locked (S320) and the drying re-starts (S330).

If the door is not opened in a predetermined time period for example, 5 minutes, it means that the user fails to recognize the malfunction. Thus, it is preferred that the door is re-locked (S320) and the drying re-starts (S330).

If the controller (now shown) detects malfunctions of various parts and operational errors in the dryer and it is determined that there is no malfunction in the dryer, the selected drying is continuously performed for a predetermined time period in a state of the door 12 being locked (S345).

Once the drying is completed cooling is performed (S360) in which the temperature t of the hot laundry is lowered to a predetermined second door-lock-release temperature T2, for example, 47° so that the user unload the laundry easily.

Specifically, the heater 15 is stopped and only the circulation fan 16 is operated. Thus, relatively low temperature air is continuously supplied to the drum 11 to lower the temperature of the laundry to the predetermined second door-lock-release temperature T2.

During the cooling, the temperature inside the drum 11 is sensed by the temperature sensor (not shown) periodically (S375). At this time, the sensed temperature t is compared with the predetermined second door-lock-release temperature T2 (S380). If the sensed temperature t is below the second door-lock-release temperature T2, the operation of the circulation fan 16 is stopped and the cooling is completed.

Once the cooling is completed the controller releases the locking of the door (S390) and the user opens the door 12 to unload the laundry.

### INDUSTRIAL APPLICABILITY

The present invention has an industrial applicability.

First, according to the present invention, the door is opened only if the temperature inside the drum is below the predetermined temperature. As a result, user safety can be enhanced.

Furthermore, as mentioned above, the dried hot laundry is prevented from being exposed to external air suddenly. As a result, spontaneous combustion of the laundry and thus fires may be prevented in advance.

1. A controlling method of a dryer comprising:
loading laundry in the dryer;
locking a door of the dryer;
performing drying for the laundry; and
determining whether there is malfunction in the dryer.

2. The controlling method of a dryer as claimed in claim 1, further comprising:
sensing the temperature inside a drum if there is malfunction and determining based on the sensed temperature whether the locking of the door is released.

3. The controlling method of a dryer as claimed in claim 2, wherein the locking of the door is released if the sensed temperature inside the drum is below a predetermined first door-lock-release temperature.

4. The controlling method of a dryer as claimed in claim 3, wherein the drying is stopped, if the locking of the door is released and the door is opened.

5. The controlling method of a drying as claims in claim 4, further comprising: re-locking the door and re-starting the drying, if a command for re-starting the drying is inputted.

6. The controlling method of a dryer as claimed in claim 3, further comprising:
re-locking the door and re-starting the drying, if the locking of the door is released and the door is not opened for a predetermined time period.

7. The controlling method of a dryer as claimed in claim 5, wherein the drying is performed for a predetermined time period, if the drying re-starts.

8. The controlling method of a dryer as claimed in claim 1, wherein the drying is performed for a predetermined time period if there is no malfunction in the dryer.

9. The controlling method of a dryer as claimed in claim 1, after performing the drying, further comprising:
cooling the dried laundry; and
sensing the temperature inside a drum of the dryer and determining based on the sensed temperature whether the locking of the door is released.

10. A controlling method of dryer as claimed in claim 9, wherein the locking of the door is released if the sensed temperature inside the drum is below a predetermined second door-lock-release temperature.

11. The controlling method of a dryer as claimed in claim 6, wherein the drying is performed for a predetermined time period, if the drying re-start
